(19) United States
(12) Patent Application Publication
(10) Pub. No.: US 2012/0013278 A1
(43) Pub. Date: Jan. 19, 2012

(54) RESISTORLESS DYNAMIC MOTOR BRAKING SYSTEM AND METHOD

(75) Inventors: Casey Hanlon, Queen Creek, AZ (US); Steve Abel, Chandler, AZ (US)

(73) Assignee: HONEYWELL INTERNATIONAL INC., Morristown, NJ (US)

(21) Appl. No.: 12/835,513

(22) Filed: Jul. 13, 2010

(51) Int. Cl. H02P 3/12

(52) U.S. Cl. 318/379

(57) ABSTRACT

Systems and methods are provided for regenerative motor braking. The regenerative braking systems and methods allow the braking torque of a multi-phase motor to be controlled while keeping currents to acceptable levels and without supplying electrical energy back to the voltage source. The regenerative braking systems and methods dissipate energy in the motor windings instead of sending this energy to the voltage source by intelligently switching the low-side switches in the inverter between the ON and OFF states at the commutation frequency while maintaining the high-side switches in the inverter in the OFF state.

### TECHNICAL FIELD

The present invention generally relates to dynamic braking of electric motors, and more particularly relates to a system and method for dynamically braking electric motors using without using a parasitic or aiding load resistor.

### BACKGROUND

When a jet-powered aircraft lands, the landing gear brakes and aerodynamic drag (e.g., flaps, spoilers, etc.) of the aircraft may not, in certain situations, be sufficient to slow the aircraft down in the required amount of runway distance. Thus, jet engines on most aircraft include thrust reversers to enhance the braking of the aircraft. When deployed, a thrust reverser redirects the rearward thrust of the jet engine to a generally or partially forward direction to decelerate the aircraft. Because at least some of the jet thrust is directed forward, the jet thrust also slows down the aircraft upon landing.

Various thrust reverser designs are commonly known, and the particular design utilized depends, at least in part, on the engine manufacturer, the engine configuration, and the propulsion technology being used. Thrust reverser designs used most prominently with jet engines fall into three general categories: (1) cascade-type thrust reversers; (2) target-type thrust reversers; and (3) pivot door thrust reversers. Each of these designs employs a different type of moveable thrust reverser component to change the direction of the jet thrust.

The moveable thrust reverser components in each of the above-described designs are moved between the stowed and deployed positions by a thrust reverser actuation control system. The thrust reverser actuation control system may include a power drive unit (PDU), which selectively supplies a drive torque. A drive train that includes one or more drive mechanisms, such as flexible rotating shafts, may interconnect the PDU to a plurality of actuators to transmit the PDU's drive torque to the actuators, which are coupled to the moveable thrust reverser components.

The PDU in many thrust reverser actuation control systems is being implemented using an electric motor. As may be appreciated, a thrust reverser PDU, when deploying the thrust reverser movable components, preferably accelerates the actuators and associated movable components as quickly as possible, and then very quickly brings the actuators and movable components to a stop. Near the end of a deploy operation, the aerodynamic load typically becomes an overhauling load, which would tend to accelerate the actuators and the electric motor. Thus, near the end of a deploy operation, the electric motor is typically configured as an electromagnetic brake to slow the actuators down.

When electrical braking of an electric machine, such as the electric motor in a thrust reverser actuation system, is required and electrical power cannot be directed back to the power source, a parasitic load resistor (PLR) or aiding load resistor (ALR) is generally provided. The PLR or ALR, which may be passively or actively controlled, is an undesirable heat source that is typically located in the thrust reverser actuation control system controller. The PLR or ALR also undesirably increases system weight.

Hence, there is a need for a system and method of dissipating electric power during electric motor braking in a thrust reverser control system (or various other systems), while simultaneously reducing the weight of the thrust reverser control system (or various other systems) and simplifying the electronic controls. The present invention addresses one or more of these needs.

### BRIEF SUMMARY

It is known in the field of motor control that shorting all of the phase windings of a spinning motor together creates braking torque, and that electrical energy is dissipated in the shorted phase windings. The present invention exploits this known phenomenon by selectively shorting the phase windings in order to modulate the degree of braking torque without sending energy back to the supply. In one embodiment, a method of dynamically braking a multi-phase motor that is coupled to a multi-phase inverter, which is adapted to be energized with a supply voltage is provided. Each phase of the multi-phase inverter includes a high-side switch and a low-side switch electrically connected in series. Each high-side switch and each low-side switch is switchable between an ON state and an OFF state, and each phase of the multi-phase motor is coupled between, and associated with, a high-side switch and a low-side switch of a different phase of the multi-phase inverter. The method includes sensing when a first condition and a second condition are met. The first condition corresponds to the multi-phase motor rotating at a speed having a value that is opposite in sign to that of a commanded motor torque, and the second condition corresponds to the supply voltage exceeding a predetermined threshold magnitude. In response to the first condition and the second condition being simultaneously met, the multi-phase motor is braked by switching all of the high-side switches to the OFF state and, while all of the high-side switches are in the OFF state, selectively switching each of the low-side switches between the OFF state and the ON state.

In another embodiment, a method of operating a thrust reverser movable component is provided. The thrust reverser movable component is coupled to a multi-phase motor, which is coupled to a multi-phase inverter that is adapted to be energized with a supply voltage. Each phase of the multi-phase inverter includes a high-side switch and a low-side switch electrically connected in series. Each high-side switch and each low-side switch is switchable between an ON state and an OFF state, and each phase of the multi-phase motor is coupled between, and associated with, a high-side switch and a low-side switch of a different phase of the multi-phase inverter. The method includes selectively switching each of the high-side switches and each of the low-side switches between the ON state and the OFF state, in accordance with a pulse width modulation (PWM) control scheme, to thereby selectively energize each phase of the multi-phase motor and cause the multi-phase motor to rotate at a rotational speed. The rotational speed of the multi-phase motor and a magnitude of the supply voltage are sensed, and a determination is made regarding whether a first condition and a second condition are met. The first condition corresponds to the rotational speed of the multi-phase motor having a value that is opposite in sign to that of a commanded motor torque, and the second condition corresponds to the supply voltage exceeding a predetermined threshold magnitude. If the first condition and the second condition are simultaneously met, the multi-phase motor is braked by switching all of the high-side switches to the OFF state and, while all of the high-side switches are in the OFF state, selectively switching each of the low-side switches between the OFF state and the ON state.

In yet another embodiment, a motor control system includes a multi-phase inverter, a multi-phase motor, and an inverter control. The multi-phase inverter is adapted to be energized with a supply voltage and is coupled to receive inverter control signals. Each phase of the multi-phase inverter includes a high-side switch and a low-side switch electrically connected in series. Each high-side switch and each low-side switch are responsive to the inverter control signals to switch between an ON state and an OFF state. The multi-phase motor includes a rotationally mounted rotor and multi-phase stator. Each phase of the multi-phase stator is coupled between, and associated with, a high-side switch and a low-side switch of a different phase of the multi-phase inverter. The inverter control is coupled to the multi-phase inverter, and is adapted to receive a command signal representative of commanded motor torque, a speed signal representative of rotor rotational speed, and a signal representative of supply voltage magnitude. The inverter control is configured, in response to these signals, to determine when a first condition is met and when a second condition is met. The first condition corresponds to the rotor rotational speed having a value that is opposite in sign to that of the commanded motor torque, and the second condition corresponds to the supply voltage magnitude exceeding a predetermined threshold magnitude. In response to the first condition and the second condition both being met, the inverter is further configured to brake the multi-phase motor by supplying inverter control signals to the multi-phase inverter that switch all of the high-side switches to the OFF state and, while all of the high-side switches are in the OFF state, selectively switch each of the low-side switches between the OFF state and the ON state.

Furthermore, other desirable features and characteristics of the dynamic motor braking control system and method will become apparent from the subsequent detailed description of the invention and the appended claims, taken in conjunction with the accompanying drawings and this background of the invention.

### BRIEF DESCRIPTION OF THE DRAWINGS

Various embodiments of the present invention will hereinafter be described in conjunction with the following drawing figures, wherein like numerals denote like elements, and wherein:

FIG. 1 depicts a perspective view of portions of an aircraft engine fan case;

FIG. 2 depicts a functional schematic diagram of an embodiment of thrust reverser actuation system in which, for illustrative purposes, the motor shown rotated out of its engine-aligned axis;

FIG. 3 depicts a schematic representation of a portion of the control circuit of FIG. 2, and its interconnection with the multi-phase motor; and

FIGS. 4-6 depict an inverter switching scheme that is implemented in the control circuit of FIG. 3 during motor braking overlaid onto the back electromagnetic force voltages generated by each phase of the multi-phase motor.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description. Thus, although the description is explicitly directed toward an embodiment that is implemented in a cascade-type thrust reverser system, in which transcowls are used as the thrust reverser moveable component, it should be appreciated that it can be implemented in other thrust reverser actuation system designs, including those described above and those known now or hereafter in the art. It should additionally be appreciated that it can be implemented in numerous and varied other systems in which regenerative motor braking is desired, and not just in thrust reverser control systems.

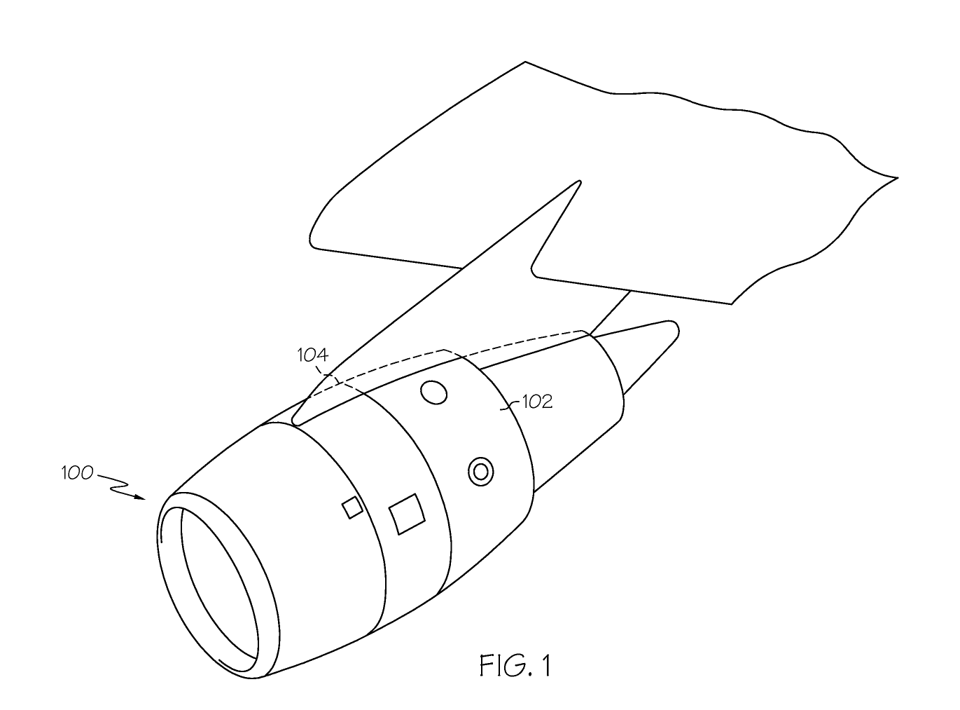

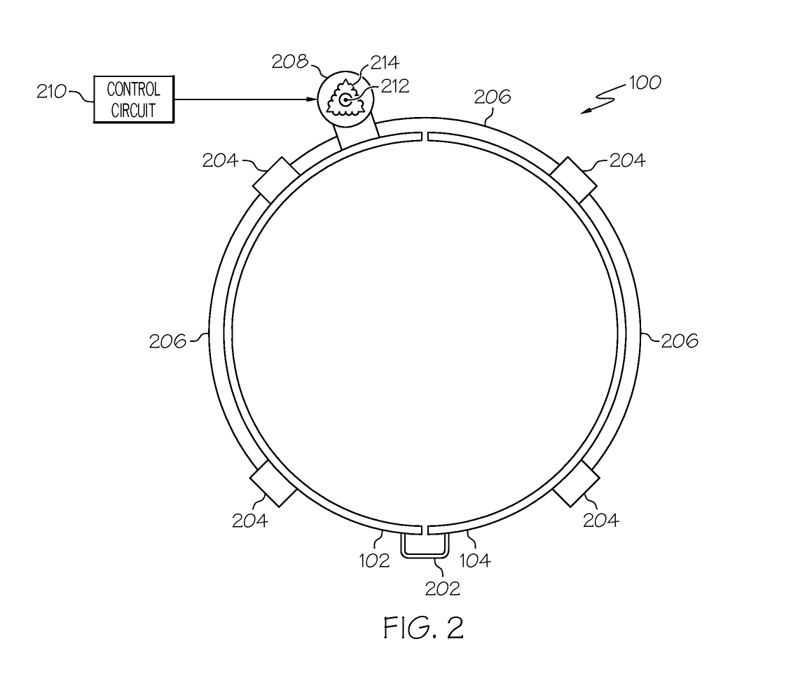

Turning now to the description, and with reference first to FIG. 1, a perspective view of portions of an aircraft jet engine fan case 100 that incorporates a cascade-type thrust reverser is depicted. The engine fan case 100 includes a pair of semi-circular transcowls 102 and 104 that are positioned circumferentially on the outside of the engine fan case 100. The transcowls 102 and 104 cover a plurality of non-illustrated cascade vanes. A mechanical link 202 (see FIG. 2), such as a pin or latch, may couple the transcowls 102 and 104 together to maintain the transcowls 102 and 104 in correct alignment on non-illustrated guides on which the transcowls 102 and 104 translate. When the thrust reversers are commanded to deploy, the transcowls 102 and 104 are translated aft. This, among other things, exposes the cascade vanes, and causes at least a portion of the air flowing through the engine fan case 100 to be redirected, at least partially, in a forward direction. This re-direction of air flow in a forward direction creates a reverse thrust, and thus works to slow the airplane.

The transcowls 102 and 104 are moved between deploy and stow positions via a thrust reverser actuation control system. An exemplary embodiment of a thrust reverser actuation control system 200 is depicted in FIG. 2, and includes a plurality of actuators 204, a plurality of drive mechanisms 206, and a power drive unit 208. The actuators 204 are individually coupled to the transcowls 102 and 104. The actuators 204 are additionally coupled to receive a drive torque and are configured, upon receipt of the drive torque, to move between a stowed position and a deployed position, to thereby move the transcowls 102 and 104 between the stow and deploy positions, respectively. In the depicted embodiment, half of the actuators 204 are coupled to one of the transcowls 102, and the other half are coupled to the other transcowl 104. It is noted that the actuators 204 may be any one of numerous actuator designs presently known in the art or hereafter designed. However, in this embodiment the actuators 204 are ballscrew actuators. It is additionally noted that the number and arrangement of actuators 204 is not limited to what is depicted in FIG. 2, but could include other numbers of actuators 204 as well. The number and arrangement of actuators 204 is selected to meet the specific design requirements of the system.

The drive mechanisms 206 are coupled between the PDU 208 and the actuators 204. It will be appreciated that the number of drive mechanisms 206 that are included in the system 200 may vary. No matter the specific number, however, each drive mechanism 206 is preferably implemented using a flexible shaft. Using flexible shafts 206 in this configuration ensures that the actuators 204 and the transcowls 102 and 104, when unlocked, move in a substantially synchronized manner. For example, when one transcowl 102 is moved, the other transcowl 104 is moved a like distance at substantially the same time. In the depicted arrangement, the rotation of the PDU 208 results in the synchronous operation of the actuators 204, via the flexible shafts 206, thereby causing the transcowls 102 and 104 to move at substantially the same rate. Other synchronization mechanisms that may be used include electrical synchronization or open loop synchronization, or any other mechanism or design that transfers power between the actuators 204.

The power drive unit (PDU) 208 is configured to selectively supply a drive torque, via the drive mechanisms 206, to the actuators 204 and transcowls 102, 104. The PDU 208 is preferably implemented as a multi-phase motor 208. In the depicted embodiment, the multi-phase motor 208 is most preferably implemented as a 3-phase electric motor. In this regard, the multi-phase motor 208 preferably includes a rotor 212 and a multi-phase stator 214. The rotor 212 is rotationally mounted and is at least partially surrounded by the multi-phase stator 214. The multi-phase stator 214 is adapted to be selectively energized and is configured, upon being energized, to cause the rotor 212 to rotate and supply the drive torque, via the drive mechanisms 206, to the actuators 204 and transcowls 104, 106. As will be described momentarily, the multi-phase motor 208 is additionally configured to selectively supply a braking torque, via the drive mechanisms 206, to the actuators 204 and transcowls 102, 104.

The thrust reverser actuation control system 200 also preferably includes a control circuit 210. The control circuit 210 receives commands from a non-illustrated engine control system such as, for example, a FADEC (full authority digital engine control), and receives various signals from a plurality of sensors. In response to these signals, the control circuit 210 selectively energizes the multi-phase motor 208. In turn, the multi-phase motor 208 supplies the drive torque to the actuators 204 via the flexible shafts 206. The control circuit 210 also controls the multi-phase motor 208 to selectively supply the above-mentioned braking torque. The manner in which the control circuit 210 is configured to implement these functions will now be described in more detail.

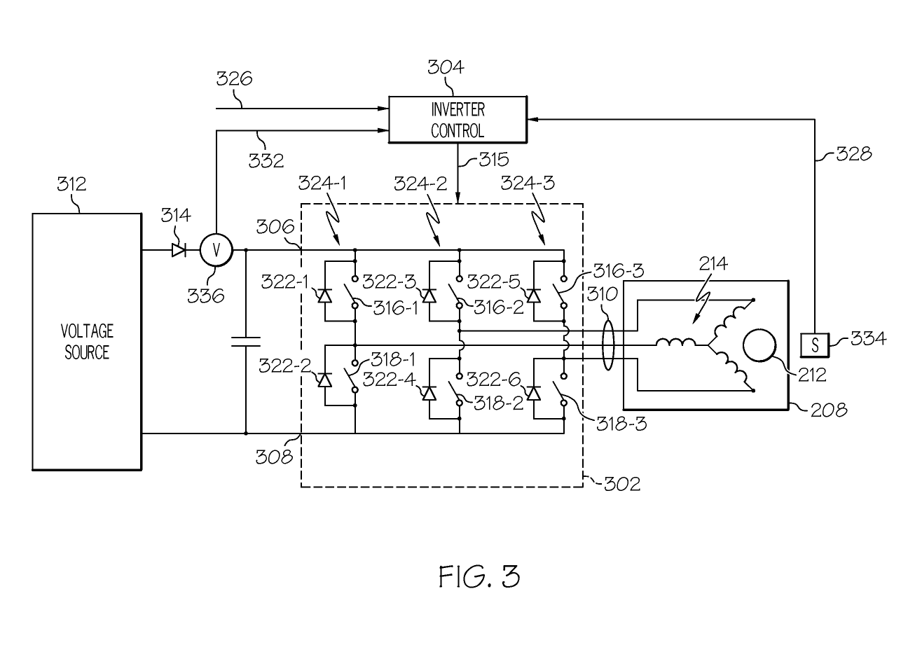

Referring now to FIG. 3, a schematic representation of a portion of the control circuit 210 and its interconnection with the multi-phase motor 208 is depicted, and includes at least a multi-phase inverter 302 and an inverter control 304. The inverter 302 includes a first DC input 306, a second DC input 308, and a plurality of AC outputs 310. The first and second DC inputs 306, 308 are coupled to a voltage source 312. The voltage source 312 is connected to the inverter 302 and is configured to supply a DC voltage and current to the inverter 302 via a diode 314. The voltage source 312 may be any one of numerous DC voltage sources. Some non-limiting examples include one or more generators, one or more fuel cells, one or more batteries (such as lead acid, nickel metal hydride, or lithium ion batteries), one or more ultra-capacitors, one or more passively or actively controlled AC-to-DC rectifiers, or a voltage bus coupled to one or more (or other) of these sources.

The inverter 302 is also coupled to receive inverter control signals 315 from the inverter control 304. The inverter 302 is configured, in response the inverter control signals 315, to operate the multi-phase motor 208 in either a motoring mode or a braking mode. In the motoring mode, the inverter 302 selectively converts DC current supplied from the voltage source 312 to AC current, and supplies the AC current, via the plurality of AC outputs 310, to the multi-phase motor 208. In the braking mode, the inverter 302 selectively shorts the phases of the multi-phase motor 208 and, using the back electromotive force (BEMF) that is generated in the multi-phase motor 208, dynamically brakes the multi-phase motor 208.

The inverter 302 may be implemented using any one of numerous multi-phase inverter configurations, but in the depicted embodiment it is implemented using a conventional 3-phase inverter configuration. As such, the depicted inverter 302 includes a plurality of high-side switches 316 (316-1, 316-2, 316-3), a plurality of low-side switches 318 (318-1, 318-2, 318-3), and a plurality of freewheeling diodes 322 (322-1, 322-2, 322-3, 322-4, 322-5, 322-6). Each phase 324 (324-1, 324-2, 324-3) of the inverter 302 includes a high-side switch 316 and a low-side switch 318 that are electrically connected in series. As is generally known, each high-side switch 316 and each low-side switch 318 is responsive to inverter control signals 315 supplied thereto to switch between an ON state and an OFF state. In the ON state, current may flow through the high-side and low-side switches 316, 318, and in the OFF state, current may not flow through the high-side and low-side switches 316, 318. It is noted that, for the sake of clarity, individual inverter control signals 315 from the inverter control 304 to each high-side and low-side switch 316, 318 are not depicted in FIG. 3. Though not explicitly depicted, it will be appreciated that the high-side and low-side switches 316, 318 may be implemented using insulated gate bipolar transistors (IGBT), MOS transistors, or any one of numerous other suitable switching devices now known, or developed in the future.

The freewheeling diodes 322 are connected within the inverter 302 to provide bidirectional current flow. More specifically, at least in the embodiment depicted in FIG. 3, three of the freewheeling diodes 322-1, 322-3, 322-5 are connected across one of the high-side switches 316, and the other three freewheeling diodes 322-2, 322-4, 322-6 are each connected across one of the low-side switches 318. With this configuration, current supplied from the multi-phase motor 208 may be supplied back to the voltage source 312 or recirculated and used to supply braking torque.

The inverter control 304 is coupled to the multi-phase inverter 302, and is adapted to receive a command signal 326 representative of a commanded motor torque, a speed signal 328 representative of rotor rotational speed, and a voltage magnitude signal 332 representative of supply voltage magnitude. The command signal 326 may be supplied from the above-mentioned engine control system (e.g., a FADEC) or some other non-illustrated system or circuit. The speed signal 328 is supplied from a rotational speed sensor 334 that is configured to sensor the rotational speed of the rotor 212, and the voltage magnitude signal 332 is supplied from a voltage sensor 336 that is configured to sense the voltage magnitude of the voltage source 312. The rotational speed sensor 334 may be implemented using any one of numerous rotational speed sensors now known or developed in the future. Moreover, the voltage sensor 336 may be implemented using any one of numerous voltage sensors now known or developed in the future. Although only one rotational speed sensor 334 and only one voltage sensor 336 are depicted, it will be appreciated that more than one of these sensors 334, 336 may be used.

The inverter control 304 is configured, in response to the command signal 326, the speed signal 328, and the voltage magnitude signal 332, to supply inverter control signals 315 to the inverter 302 that cause the multi-phase motor 208 to operate in either the motoring mode or the braking mode. More specifically, the inverter control 304 is configured, in response to these signals 326, 328, 332, to determine if two conditions are simultaneously met and, based on this determination, to supply inverter control signals 315 to the inverter 302 that cause the multi-phase motor 208 to operate in either the motoring mode or the braking mode. If the inverter control 304 determines that the two conditions are not simultaneously met, then the inverter control signals 315 supplied to the inverter 302 cause the multi-phase motor 208 to operate in the motoring mode. Conversely, if these two conditions are simultaneously met, then the inverter control signals 315 supplied to the inverter 302 cause the multi-phase motor 208 to operate in the braking mode.

The two conditions mentioned above are referred to herein as a first condition and a second condition. The first condition corresponds to the rotational speed of the rotor 212 having a value that is opposite in sign to that of the commanded motor torque. The second condition corresponds to the magnitude of the supply voltage exceeding a predetermined threshold magnitude. These two conditions are simultaneously met when deceleration or overhauling loads are present, indicating the need to operate the multi-phase motor 208 in the braking mode.

To operate the multi-phase motor 206 in the motoring mode, the inverter control signals 315 supplied to the multi-phase inverter 302 selectively switch each of the high-side switches 316 and each of the low-side switches 318 between the ON state and the OFF state in accordance with a pulse width modulation (PWM) control scheme. As a result, each phase of the multi-phase stator 214 is selectively energized, which causes the rotor 212 to produce torque and acceleration to a rotational speed that corresponds to the command signal 326. It will be appreciated that the PWM control scheme may be any one of numerous PWM control schemes now known or developed in the future.

To operate the multi-phase motor 208 in the braking mode, the inverter control signals 315 supplied to the multi-phase inverter 302 switch all of the high-side switches 316 to the OFF state. While all of the high-side switches 316 are in the OFF state, the inverter control signals 315 selectively switch each of the low-side switches 318 between the OFF state and the ON state. In accordance with a preferred embodiment, the inverter control 304 selectively switches each of the low-side switches between the OFF state and the ON state according to the following scheme: (1) a low-side switch 318 is switched to the OFF state only when the BEMF voltage (V_{BEMF}) generated by its associated phase of the multi-phase stator 214 is positive and (2) a low-side switch 318 is switched to the ON state only when the V_{BEMF} generated by its associated phase of the multi-phase stator 214 is negative. This scheme regulates the BEMF-generated current, and ensures undesirable flyback current does not flow to the voltage source 312.

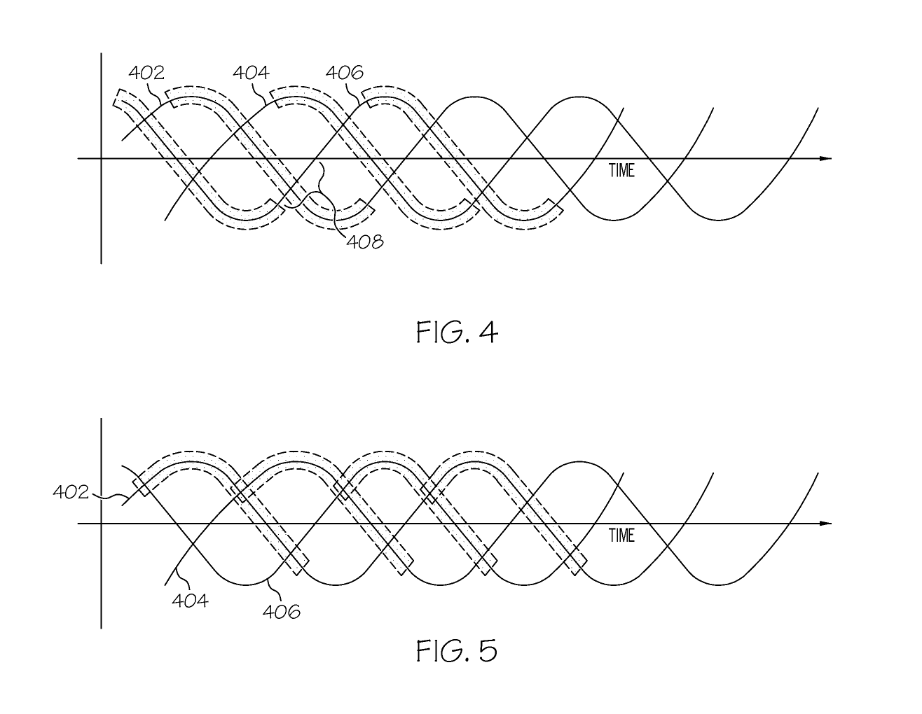

To more clearly illustrate the above-described scheme that is implemented during motor braking, attention should now be made to FIG. 4, which depicts the switching scheme overlaid onto the V_{BEMF} generated by each phase of the multi-phase motor 208. In the depicted embodiment, in which the multi-phase motor 208 is implemented with a 3-phase stator 214, it is seen that as the rotor 212 rotates each phase of the multi-phase stator 214 generates a V_{BEMF} having a positive half-cycle and a negative half-cycle. In FIG. 4, the V_{BEMF} for a first phase is labeled “402,” for a second phase is labeled “404,” and for a third phase is labeled “406.” Additionally, the OFF state for the low-side switch 318 associated with each phase 214 is illustrated using regions enveloped by the dotted lines. It is thus seen that the inverter control signals 315 supplied to the inverter 302 selectively switch each low-side switch 318 from the OFF state to the ON state during a negative half-cycle of the V_{BEMF} generated by its associated phase of the multi-phase stator 214, and selectively switch each low-side switch 318 from the ON state to the OFF state during a positive half-cycle of the V_{BEMF} generated by its associated phase of the multi-phase stator.

It is additionally noted that the inverter control signals 315 supplied to the inverter 302, while operating the multi-phase motor 208 in the braking mode, selectively switch each low-side switch 318 between the ON state and the OFF state at the motor commutation frequency, and not at the relatively high PWM switching frequency of the PWM control scheme. While operating the multi-phase motor 208 in the braking mode, each of the low-side switches 318 will additionally have an ON state duty cycle that is preferably about 50%. That is, each low-side switch 318 will be in the ON state for about half of their electrical cycle. Moreover, each low-side switch 318 is operated in accordance with what is referred to herein as a “brake-effective duty.” The brake-effective duty is defined herein as that portion of the ON state duty cycle that occurs during the negative half-cycle of the V_{BEMF} generated by its associated phase of the multi-phase motor 208. For clarity, the brake-effective duty for the low-side switch 31-2 associated with the second phase 404 is labeled “408” in FIG. 4.

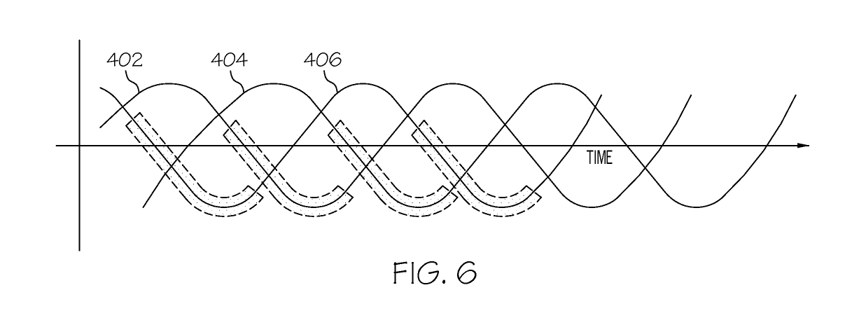

The braking of the multi-phase motor 208 may be varied by varying the brake-effective duty of each low-side switch 318. This is illustrated more clearly in FIGS. 5 and 6, which depict two variations in the brake-effective duty. The brake-effective duty of each low-side switch 318 depicted in FIG. 5 is increased (relative to FIG. 4), whereas the brake-effective duty of each low-side switch 318 depicted in FIG. 6 is decreased (relative to FIG. 4). The relative increase in brake-effective duty depicted in FIG. 5 would result in relatively more braking, whereas the relative increase in brake-effective duty depicted in FIG. 6 would result in relatively less braking.

The motor braking scheme described herein was modeled for 4-pole, 3-phase motor having a phase inductance of about 0.08 mH, and a maximum current limit of 200 amps. The commutation rate for this motor, when rotating at 12,000 rpm, is 1200 Hz (400 Hz/phase), which is well below the normal PWM switching frequency (about 10,000 Hz). For this motor, the BEMF at 12,000 rpm is about 165 volts, and for the given phase inductance the current slew rate is about 2.1×10⁶ amps/sec. At a brake-effective duty of about 5% at 1200 Hz, the current ripple is about 88 amps, which is an acceptable level given the maximum current limit of 200 amps.

The regenerative braking system and method described herein allows the braking torque of the multi-phase motor 208 to be controlled while keeping currents to acceptable levels and without supplying electrical energy back to the voltage source 312. The regenerative braking system and method dissipates energy in the motor windings instead of sending this energy to the voltage source 312 by intelligently switching the low-side switches 318 at the commutation frequency and switching the high-side switches 316 to the OFF state. The system and method thus provides regenerative motor braking with a reduced weight thrust reverser control system (or various other systems) and with a simplified electronic controls.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of dynamically braking a multi-phase motor that is coupled to a multi-phase inverter that is adapted to be energized with a supply voltage, wherein each phase of the multi-phase inverter includes a high-side switch and a low-side switch electrically connected in series, each high-side switch and each low-side switch switchable between an ON state and an OFF state, and each phase of the multi-phase motor is coupled between and associated with a high-side switch and a low-side switch of a different phase of the multi-phase inverter, the method comprising the steps of:
sensing when a first condition is met, the first condition corresponding to the multi-phase motor rotating at a speed having a value that is opposite in sign to that of a commanded motor torque;
sensing when a second condition is met, the second condition corresponding to the supply voltage exceeding a predetermined magnitude; and
in response to the first condition and the second condition being simultaneously met, braking the multi-phase motor by:
(i) switching all of the high-side switches to the OFF state; and
(ii) while all of the high-side switches are in the OFF state, selectively switching each of the low-side switches between the OFF state and the ON state.

2. The method of claim 1, wherein:
the multi-phase motor rotates at a commutation frequency; and
each low-side switch is selectively switched between the ON state and the OFF state at the commutation frequency.

3. The method of claim 2, wherein:
each phase of the multi-phase motor generates a voltage (V_{BEMF}) having a positive half-cycle and a negative half-cycle;
each low-side switch is switched from the OFF state to the ON state during a negative half-cycle of the V_{BEMF} generated by its associated phase of the multi-phase motor; and
each low-side switch is switched from the ON state to the OFF state during a positive half-cycle of the V_{BEMF} generated by its associated phase of the multi-phase motor.

4. The method of claim 3, wherein:
each low-side switch is selectively switched between the ON state and the OFF state at the commutation frequency and with an ON state duty cycle;
the ON state duty cycle of each low-side switch is about 50%; and
each low-side switch has a brake-effective duty, the brake-effective duty being that portion of the ON state duty cycle that occurs during the negative half-cycle of the V_{BEMF} generated by its associated phase of the multi-phase motor.

5. The method of claim 4, further comprising:
varying the braking of the multi-phase motor by varying the brake-effective duty of each low-side switch.

6. The method of claim 1, further comprising:
in response to the first condition and the second condition not being simultaneously met, selectively switching each of the high-side switches and each of the low-side switches between the ON state and the OFF state, in accordance with a pulse width modulation (PWM) control scheme, to thereby selectively energize each phase of the multi-phase motor and cause the multi-phase motor to rotate at a rotational speed.

7. A method of operating a thrust reverser movable component that is coupled to a multi-phase motor, the multi-phase motor coupled to a multi-phase inverter that is adapted to be energized with a supply voltage, wherein each phase of the multi-phase inverter includes a high-side switch and a low-side switch electrically connected in series, each high-side switch and each low-side switch switchable between an ON state and an OFF state, and each phase of the multi-phase motor is coupled between and associated with a high-side switch and a low-side switch of a different phase of the multi-phase inverter, the method comprising the steps of:
selectively switching each of the high-side switches and each of the low-side switches between the ON state and the OFF state, in accordance with a pulse width modulation (PWM) control scheme, to thereby selectively energize each phase of the multi-phase motor and cause the multi-phase motor to rotate at a rotational speed and move the thrust reverser movable component;
sensing the rotational speed of the multi-phase motor;
sensing a magnitude of the supply voltage;
determining if a first condition is met, the first condition corresponding to the rotational speed of the multi-phase motor having a value that is opposite in sign to that of a commanded motor torque;
determining if a second condition is met, the second condition corresponding to the supply voltage exceeding a predetermined threshold magnitude; and
if the first condition and the second condition are simultaneously met, braking the multi-phase motor by:
(i) switching all of the high-side switches to the OFF state, and
(ii) while all of the high-side switches are in the OFF state, selectively switching each of the low-side switches between the OFF state and the ON state.

8. The method of claim 7, wherein:
the multi-phase motor rotates at a commutation frequency; and
each low-side switch is selectively switched between the ON state and the OFF state at the commutation frequency.

9. The method of claim 8, wherein:
each phase of the multi-phase motor generates a back electromotive force voltage (V_{BEMF}) having a positive half-cycle and a negative half-cycle;
each low-side switch is switched from the OFF state to the ON state during a negative half-cycle of the V_{BEMF} generated by its associated phase of the multi-phase motor; and
each low-side switch is switched from the ON state to the OFF state during a positive half-cycle of the V_{BEMF} generated by its associated phase of the multi-phase motor.

10. The method of claim 9, wherein
each low-side switch is selectively switched between the ON state and the OFF state at the commutation frequency and with an ON state duty cycle;
the ON state duty cycle of each low-side switch is about 50%; and
each low-side switch has a brake-effective duty, the brake-effective duty being that portion of the ON state duty cycle that occurs during the negative half-cycle of the V_{BEMF} generated by its associated phase of the multi-phase motor.

11. The method of claim 10, further comprising:
varying the braking of the multi-phase motor by varying the brake-effective duty of each low-side switch.

12. A motor control system, comprising:
a multi-phase inverter adapted to be energized with a supply voltage and coupled to receive inverter control signals, each phase of the multi-phase inverter including a high-side switch and a low-side switch electrically connected in series, each high-side switch and each low-side switch responsive to the inverter control signals to switch between an ON state and an OFF state;
a multi-phase motor including a rotationally mounted rotor and multi-phase stator, each phase of the multi-phase stator coupled between, and associated with, a high-side switch and a low-side switch of a different phase of the multi-phase inverter; and
an inverter control coupled to the multi-phase inverter, the inverter control adapted to receive a command signal representative of commanded motor torque, a speed signal representative of rotor rotational speed, and a signal representative of supply voltage magnitude, the inverter control configured, in response to these signals, to:
(i) determine when a first condition is met, the first condition corresponding to the rotor rotational speed having a value that is opposite in sign to that of the commanded motor torque,
(ii) determine when a second condition is met, the second condition corresponding to the supply voltage magnitude exceeding a predetermined threshold magnitude, and
(iii) in response to the first condition and the second condition both being met, braking the multi-phase motor by supplying inverter control signals to the multi-phase inverter that:
(a) switch all of the high-side switches to the OFF state; and
(b) while all of the high-side switches are in the OFF state, selectively switch each of the low-side switches between the OFF state and the ON state.

13. The system of claim 12, wherein:
the rotor rotates at a commutation frequency; and
the inverter control signals supplied by the inverter control selectively switch each low-side switch between the ON state and the OFF state at the commutation frequency.

14. The system of claim 13, wherein:
each phase of the multi-phase stator generates a back electromotive force voltage (V_{BEMF}) having a positive half-cycle and a negative half-cycle;
the inverter control signals supplied by the inverter control selectively switch each low-side switch from the OFF state to the ON state during a negative half-cycle of the V_{BEMF} generated by its associated phase of the multi-phase stator; and
the inverter control signals supplied by the inverter control selectively switch each low-side switch from the ON state to the OFF state during a positive half-cycle of the V_{BEMF} generated by its associated phase of the multi-phase stator.

15. The system of claim 14, wherein:
the inverter control signals supplied by the inverter control selectively switch each low-side switch between the ON state and the OFF state at the commutation frequency and with an ON state duty cycle;
the ON state duty cycle of each low-side switch is about 50%; and
each low-side switch has a brake-effective duty, the brake-effective duty being that portion of the ON state duty cycle that occurs during the negative half-cycle of the V_{BEMF} generated by its associated phase of the multi-phase motor.

16. The system of claim 15, wherein the inverter control is further configured to vary the braking of the multi-phase motor by varying the brake-effective duty of each low-side switch.

17. The system of claim 12, wherein the inverter control is further configured, in response to the first condition and the second condition not being simultaneously met, to selectively switch each of the high-side switches and each of the low-side switches between the ON state and the OFF state, in accordance with a pulse width modulation (PWM) control scheme, to thereby selectively energize each phase of the multi-stator and cause the rotor to rotate at a rotational speed and supply a drive torque.

18. The system of claim 17, further comprising:
a movable thrust reverser component coupled to receive the drive torque from the rotor.

19. The system of claim 18, further comprising:
an actuator coupled between the rotor and the movable thrust reverser component.

20. The system of claim 19, further comprising:
a flexible shaft coupled between the rotor and the actuator.
